(19) United States
(12) Patent Application Publication
(10) Pub. No.: US 2019/0199096 A1
(43) Pub. Date: Jun. 27, 2019

(54) MULTI-TERMINAL MODULAR DC-DC CONVERTER FOR DC NETWORKS

(71) Applicant: THE GOVERNORS OF THE UNIVERSITY OF ALBERTA, Edmonton (CA)

(72) Inventors: Gregory Joseph KISH, Edmonton (CA); Sunny Hsiang-Yu KUNG, Edmonton (CA)

(21) Appl. No.: 16/227,649

(22) Filed: Dec. 20, 2018

Related U.S. Application Data
(60) Provisional application No. 62/609,217, filed on Dec. 21, 2017.

(51) Int. Cl. H02J 3/36; H02M 3/155

(52) U.S. Cl. CPC H02J 3/36; H02M 3/155

(57) ABSTRACT

Multi-terminal HV DC-DC converters are required to facilitate future HVDC infrastructure with the ability to interconnect and manage power flow between multiple HVDC networks. Existing topologies offer limited modularity and scalability, making them difficult to implement in the fast-growing HVDC industry. In this disclosure, a multi-terminal modular multilevel converter (MT-MMC) is proposed as the first truly modular multi-terminal HV DC-DC converter. The MT-MMC is made up of multiple subconverters that can be controlled individually with de-centralized controllers, allowing easy reconfiguration of the converter power circuit. The MT-MMC also realizes reductions in semiconductor effort and magnetic requirement when compared with conventional multi-terminal solutions. Case studies are conducted to demonstrate the versatility of the MT-MMC, and a comparative analysis is performed to highlight the advantages of the MT-MMC. Operation and performance of the MT-MMC are verified by simulation.

### CROSS-REFERENCE TO RELATED APPLICATIONS

The present application claims all benefit including priority to U.S. Provisional Patent Application 62/609,217, filed Dec. 21, 2017, and entitled “MULTI-TERMINAL MODULAR DC-DC CONVERTER FOR DC NETWORKS”, the entirety of which is hereby incorporated by reference.

### FIELD

Embodiments of the present disclosure relate generally to the field of DC converters, and some embodiments particularly relate to the field of multi-terminal DC-DC converters.

### INTRODUCTION

DC transmission has multiple benefits over AC transmission for bulk energy transfer over long distances, including higher efficiency and lower transmission line cost [1]. AC power grids all over the world are becoming increasingly overburdened due to the constant increase in power demand, motivating the utilization of backbone HVDC transmission lines to enable bulk energy transfer between ac systems and to connect metropolises with distant renewable energy generation plants. To ensure system reliability and power management on a continental level, the interconnection of multiple DC systems is a necessity in the near future. The challenge lies in the interfacing of and the power flow control between multiple HVDC lines with different voltage ratings, power requirements and converter technologies.

### SUMMARY

In accordance with an aspect of the present disclosure, there is provided a multi-terminal DC-DC converter including: a plurality of subconverter rows, each row including a plurality of independently-controllable subconverter circuits; the plurality of subconverter rows including a first subconverter row and an adjacent second subconverter row, wherein subconverter circuits of the first subconverter row having interconnected terminals connected to terminals of corresponding subconverter circuits of the second subconverter row, the interconnected terminals of the first subconverter row providing a DC terminal.

### DESCRIPTION OF THE FIGURES

Reference will now be made to the drawings, which show by way of example embodiments of the present disclosure.

FIG. 1A and FIG. 1B show two approaches for interconnecting multiple DC networks. FIG. 1A shows a multi-converter, and FIG. 1B shows a multi-terminal DC-DC converter.

FIG. 2A and FIG. 2B show two example multi-terminal HV DC-DC converter topologies, each shown with three DC terminals.

FIG. 3 shows an example structure showing aspects of an MT-MMC.

FIG. 4A, FIG. 4B and FIG. 4C show three example SC designs based on non-isolated DC-DC topologies.

FIG. 5A shows an example voltage stacking mechanism.

FIG. 5B shows an example current splitting mechanism.

FIG. 6A and FIG. 6B show two single-phase variants of the designs in FIG. 4A and FIG. 4B respectively.

FIG. 7 shows an example decentralized inner layer controller for each SC.

FIG. 8 shows an example centralized outer layer terminal power flow controller for MT-MMC.

FIGS. 9A, 9B, 9C and 9D show terminal voltage and power flows for four different cases.

FIGS. 10A, 10B and 10C show simulation results of an example MT-MMC designed for Case 3.

FIGS. 11A, 11B and 11C show simulation results of an example MT-MMC designed for Case 4.

FIGS. 12A, 12B and 12C show alternate subconverter designs.

FIGS. 13A and 13B shows design variations with arms replaced with series-cascaded switches.

FIG. 14 shows alternate filter block designs.

FIGS. 15A and 15B shows design variations where a transformer is replaced with series-cascaded submodules and capacitors.

FIG. 16 shows aspects of an example single-layer controller.

FIG. 17 shows aspects of an example converter design.

FIGS. 18, 19, 20 and 21 show four example SC topologies that integrate center-tapped winding transformers within the SC structure.

FIG. 22 shows aspects of an example three-phase transformer circuit.

### DESCRIPTION OF EXAMPLE EMBODIMENTS

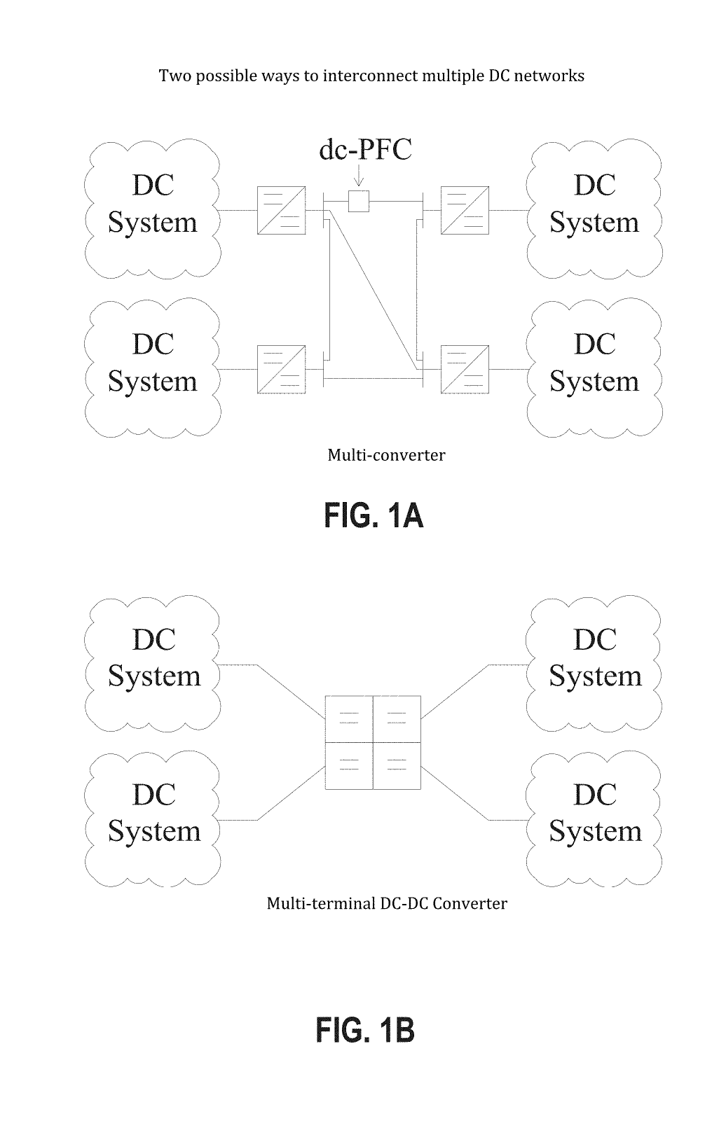

FIG. 1A illustrates a multi-converter solution, where a DC-DC converter is installed at each HVDC system and one or more DC power flow controllers are installed in the grid. The major drawback of this solution is its high cost, since multiple converters and additional HVDC lines are required to ensure the reliability and control of the DC grid. FIG. 1B illustrates a single-converter solution, where only one multi-terminal HV DC-DC converter is required. The multi-terminal converter needs to satisfy the following functionalities, which are the extension of the functionalities of two-terminal DC-DC converters established in [2]:
1. Multiple DC voltage stepping
2. Control and regulation of DC power flow between multiple systems
3. DC fault management
4. Interfacing different DC technologies, like monopolar with bipolar DC systems
5. High modularity to accommodate future DC systems

Many multi-terminal DC-DC converters have been proposed for applications in renewable energy integration or at the distribution level, e.g. [3], [4], but they are not suitable for HVDC transmission application since they cannot cost-effectively scale up their voltage and power ratings. In [5], [6], a multi-input multi-output modular multilevel DC-DC converter (MIMO-MMC) is proposed with high modularity and scalability. However, to reach the voltage and power rating required for HVDC networks, hundreds of subconverters are required in a MIMO-MMC, thus decreasing its efficiency exponentially to well below the standards for transmission applications.

The conventional solution for a multi-terminal HV DC-DC converter is the multi-port dual-active-bridge modular multilevel converter (MT-DAB-MMC), which is the multi-terminal version of the DAB-MMC and shown in 2A. The MT-DAB-MMC is easily scalable and its operating principle is well understood, but it requires a high number of semiconductor switches and multiple transformers that are rated for the full amount of DC power transfer, because it employs a two-stage DC-AC-DC conversion. This translates to a high cost for the MT-DAB-MMC. In [7], a LCL circuitry is implemented to replace the multi-winding transformer and achieve a lower magnetic requirement, but the topology still uses two-stage conversion and requires the same amount of semiconductor effort as the MT-DAB-MMC.

In [8], a non-isolated multi-terminal HV DC-DC converter is proposed, which relinquishes galvanic separation between dc terminals in exchange for considerable reduction in semiconductor and magnetic efforts. The converter, termed multiport DC autotransformer (MDC-AUTO), requires multiple transformers that are only rated for a fraction of the full DC power transfer, and is shown in 2b. The MDC-AUTO uses modular multilevel converters (MMC) as its subconverters, which are themselves modular and can be rated for HVDC applications. However, each MMC has to be designed differently based on the power flow between DC terminals, and future additions of DC terminals would require the re-design of the MMCs and the transformers. Therefore, the MDC-AUTO is not a truly modular solution. Furthermore, in the MDC-AUTO, there is significant DC stress across the transformer windings, which complicates transformer design due to insulation requirements.

This disclosure describes an alternative solution to the MT-DAB-MMC and MDC-AUTO, termed multi-terminal DC-DC MMC (MT-MMC), which has a truly modular structure and utilizes subconverters with de-centralized controllers to ensure high scalability and reliability. The MT-MMC requires a lower semiconductor effort than the MT-DAB-MMC and, unlike the MT-DAB-MMC and MDC-AUTO, it does not require a centralized AC-link, which translates to a much reduced magnetic requirement.

### Multi-Terminal MMC Structure

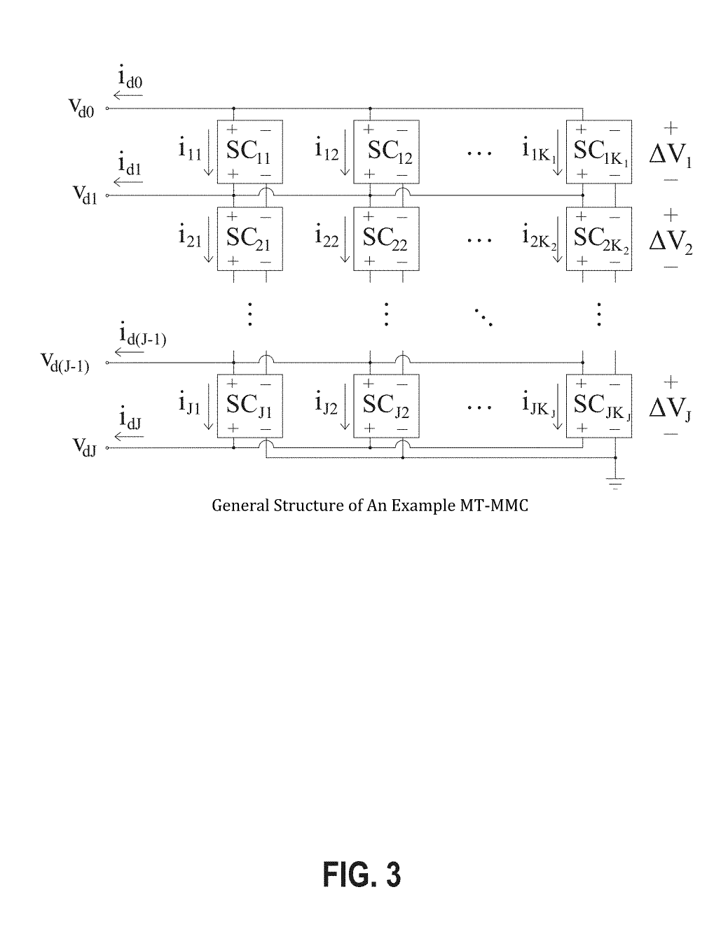

The proposed generalized MT-MMC structure is shown in FIG. 3. The topology bears resemblance to the LV/MV modular structure in [6], with J rows each having Kⱼ subconverters (SCs) to allow (J+1) DC connection terminals. The SCs are each labeled as SCⱼₖ, with j denoting a row number and k denoting a column number. Each SCⱼₖ supports a DC voltage of ΔVⱼ between its two positive nodes, with a DC current iⱼₖ passing through the SC between its two positive nodes. The DC terminal voltage and currents of the MT-MMC are labeled as V_{dj} and i_{dj}, respectively.

### Subconverter Design

The SCs being utilized in the proposed MT-MMC must satisfy the following requirements:
i. Support a DC voltage between its terminals;
ii. Regulate a DC current between its terminals;
iii. Ensure charge balancing of internal capacitors.

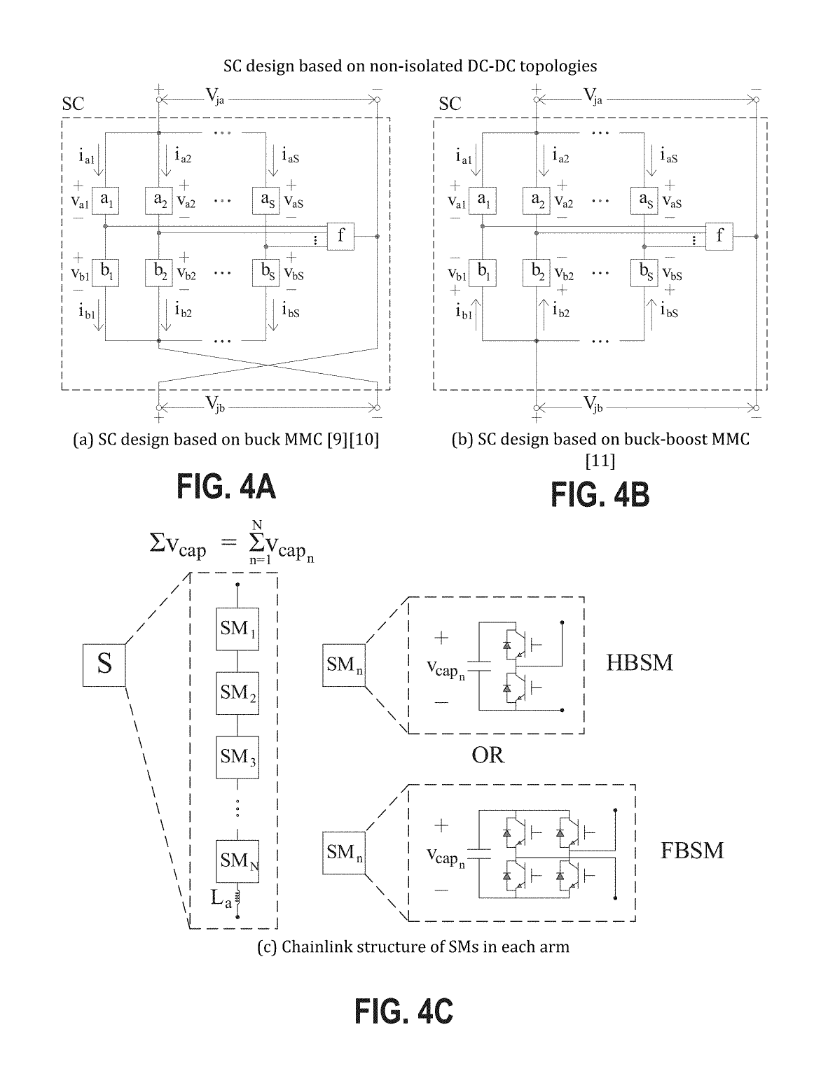

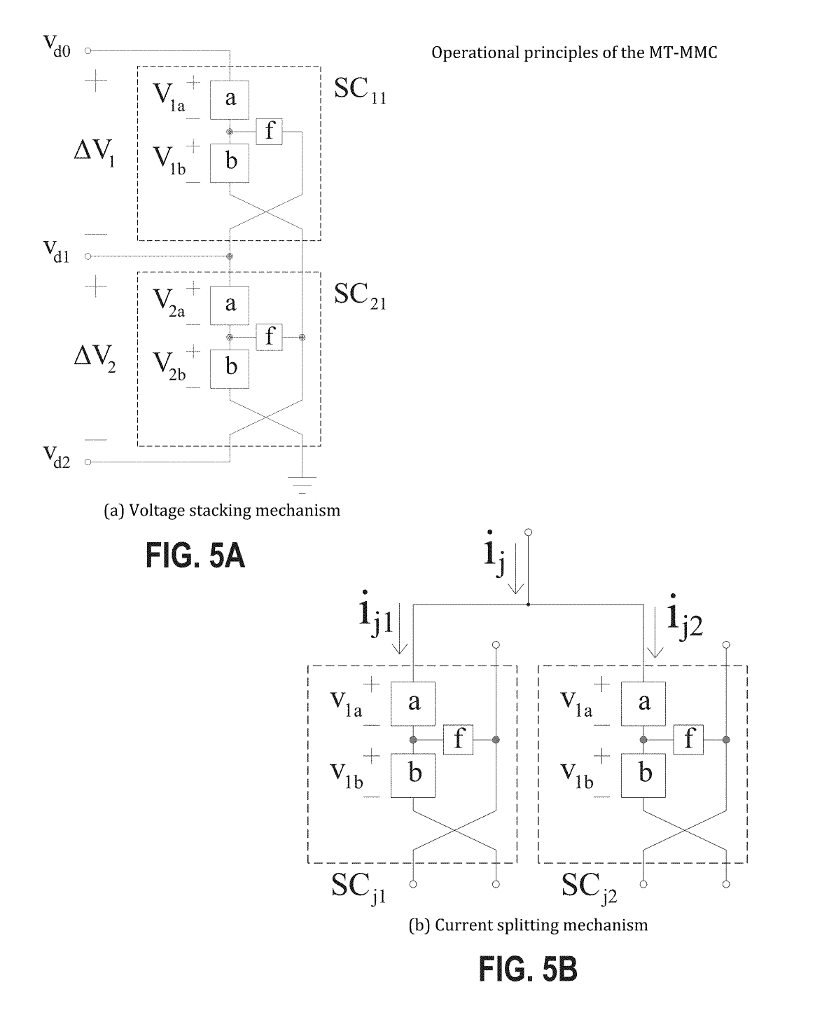

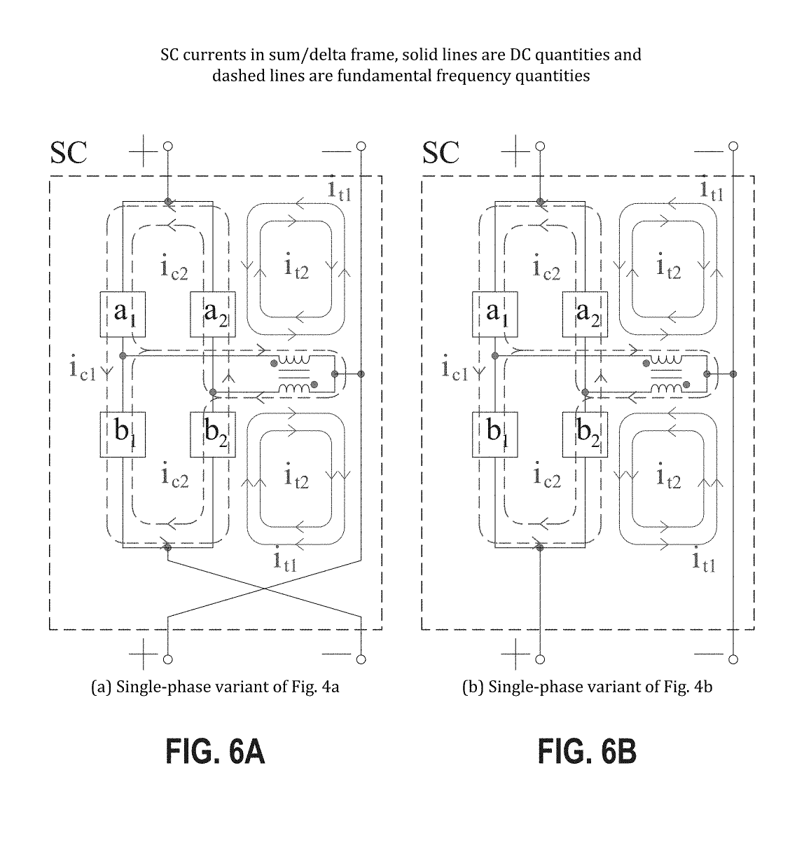

To realize HV DC-DC conversion with high efficiency and low harmonic distortion, it is desirable to utilize the chainlink structure of capacitive submodules (SM) found in MMCs. This disclosure describes two SC types derived from MMC-based two-terminal non-isolated HV DC-DC converters. FIG. 4A is a high-stepping SC based on buck MMC [9][10], and is most suitable when ΔVⱼ>>0. FIG. 4B is a low-stepping SC based on buck-boost MMC [11], and is most suitable when ΔVⱼ≈0. Each SC includes S interleaved strings of converter arms, and each string is made up of upper arms aₛ and lower arms bₛ. A minimum of two strings are required for a current to circulate internally to achieve internal charge balance between arms, but the SC can be designed with higher number of arms to increase power transfer capability. An AC filter (denoted f in FIGS. 4A and 4B) is required for each SC, and it can be a coupled inductor for two-string SCs or a zig-zag transformer for three-string SCs. vₐₛ and iₐₛ are the voltage and current for the upper arm in the sth string, and v_{bs} and i_{bs} are the voltage and current for the lower arm in the sth string. Each arm may contain N SMs, and the SMs can be of the conventional half-bridge type (HBSM) or the full-bridge type (FBSM) to allow different AC voltage modulation strategies as shown in FIG. 4C. Other types of SMs may also be used, such as, for example, the clamp double submodule (CDSM). The sum of capacitor voltage in one arm, Σv_{cap}, determines the maximum voltage the arm can support. Vⱼₐ and V_{jb} are the average component of SC port voltages, and are defined as:

$$\begin{matrix}{V}_{ja} = \frac{1}{S} ( {v}_{a 1} + {v}_{a 2} + … + {v}_{aS} ) & ( 1 ) \\ {V}_{jb} = \frac{1}{S} ( {v}_{b 1} + {v}_{b 2} + … + {v}_{bS} ) & ( 2 )\end{matrix}$$

### Voltage Stacking and Current Splitting Mechanisms

The MT-MMC achieves its high modularity, scalability and reliability with two mechanisms: the stacking of SC arm voltages and the splitting of DC currents entering a row of SCs. These two mechanisms are illustrated in FIGS. 5A and 5B for the high-stepping SC in 4A, where the S strings of upper and lower arms are grouped together for presentation simplicity.

The lowest DC terminal voltage v_{dj} (see FIG. 3) is established by the lower arms of row j, and higher DC terminal voltages in the MT-MMC can be established by series-stacking SC rows with desired ΔVⱼ:

v_{dJ}=V_{Jb} (3)

v_{d(j-1)}=v_{dj}+ΔVⱼ, ∀j ∈ [1, J] (4)

FIG. 4 reveals that for the two proposed SC designs,

ΔVⱼ=Vⱼₐ (FIG. 4A) (5)

ΔVᵢ=Vⱼₐ−V_{jb} (FIG. 4B) (6)

This voltage stacking mechanism is illustrated in FIG. 5A, where three DC voltage levels v_{d0}, v_{d1}, v_{d2} are established by series stacking two rows each having one SC. To accommodate future installation of DC systems, additional DC terminals can be created by modularly series-stacking rows of SCs (increasing J in FIG. 3).

Depending on the power flow requirement at each DC terminal, the DC current going through each row of SCs may vary. For a row with high DC current, that current can be split by adding paralleling SCs to the row, thus reducing the DC current going through each SC in the row. In most cases, it is desirable for the current to split evenly among SCs to minimize current stress throughout the MT-MMC:

$${i}_{jk} = \frac{{i}_{j}}{{K}_{j}} \qquad ( 7 )$$

This current splitting mechanism is illustrated in FIG. 5B, where the two SCs in a row j split the DC current going into the row, iⱼ. To accommodate future increase in terminal power flow requirement, power transfer capability of a row can be increased by modularly adding parallel SCs in the row (increasing Kⱼ in FIG. 3).

Both increasing J (number of rows) and Kⱼ (number of SCs within jth row) can be done without disturbing the rest of power circuit, since additional SCs are only electrically connected to their neighboring SCs, and each SC can be controlled by a de-centralized controller that is independent from other SCs. This provides a high degree of modularity to the MT-MMC, allowing the converter to easily accommodate additional DC terminal connections and increase power transfer capability. When a SC fails in a row with multiple SCs, overall converter operation can be maintained for the MT-MMC with reduced power transfer capability without losing DC terminal connections. Table I summarizes the comparison in modularity between MT-MMC, MT-DAB-MMC and MDC-AUTO. The high modularity and the resulting high reliability of the MT-MMC makes it a suitable topology for the fast-growing HVDC industry.

TABLE I
Modularity Comparison of Multi-Terminal Converters

| | MT-MMC | MT-DAB-MMC | MDC-AUTO |
|---|---|---|---|
| Adding DC | Add row of SCs (J ↑) | Add MMC, redesign | Add MMC, redesign |
| terminal | | transformer | transformer |
| Increasing | Increase number of | Redesign MMC Add | Redesign MMC Add |
| power flow | SCs within a row | paralleling arms | paralleling arms |
| | (Kⱼ ↑) | | |
| Single SC | Reduced power flow | Loss of one DC terminal | Loss of one DC |
| failure | capability | Reduced power flow | terminal |
| | | capability | |

### MT-MMC Control Design

### Subconverter Control Scheme

In [11], the authors developed a control scheme for the buck-boost MMC that can be adopted for the control of both SC types in FIG. 4. Similar to the traditional DC-AC MMC, the symmetry between upper arm and lower arm quantities in a SC can be exploited to decouple their DC and fundamental frequency components. By design, for both SC types in FIG. 4, the current and voltage quantities can be mapped into a sum/delta frame to decouple the DC and fundamental frequency components. The transformed state currents are shown in FIG. 6 for the single-phase variants of the SCs in FIG. 4, where two strings of arms are implemented and the AC filter is a coupled inductor. The mapping transformation matrices in [11] can be modified for FIG. 6A:

$$\begin{matrix}{i}^{′} = {T}_{i} i = {[ \begin{matrix}{i}_{t 1} & {i}_{t 2} & {i}_{c 1} & {i}_{c 2}\end{matrix} ]}^{T} & ( 8 ) \\ {v}^{′} = {T}_{v} v = {[ \begin{matrix}{v}_{t 1} & {v}_{t 2} & {v}_{c 1} & {v}_{c 2}\end{matrix} ]}^{T} & ( 9 ) \\ {v}_{c}^{′} = {T}_{v} {v}_{c} = {[ \begin{matrix}{v}_{cap , t 1} & {v}_{cap , t 2} & {v}_{cap , c 1} & {v}_{cap , c 2}\end{matrix} ]}^{T} \\ where & ( 10 ) \\ i = {[ \begin{matrix}{i}_{a 1} & {i}_{b 1} & {i}_{a 2} & {i}_{b 2}\end{matrix} ]}^{T} & ( 11 ) \\ v = {[ \begin{matrix}{v}_{a 1} & {v}_{b 1} & {v}_{a 2} & {v}_{b 2}\end{matrix} ]}^{T} & ( 12 ) \\ {v}_{c} = {[ \begin{matrix}Σ {v}_{cap , a 1} & Σ {v}_{cap , b 1} & Σ {v}_{cap , a 2} & Σ {v}_{cap , b2}\end{matrix} ]}^{T} & ( 13 ) \\ {T}_{i} {=}^{△} \frac{1}{2} [ \begin{matrix}1 & - 1 & 1 & - 1 \\ - 1 & - 1 & - 1 & - 1 \\ \frac{1}{2} & \frac{1}{2} & - \frac{1}{2} & - \frac{1}{2} \\ 1 & - 1 & - 1 & 1\end{matrix} ] {T}_{v} {=}^{△} \frac{1}{4} [ \begin{matrix}- 1 & 1 & - 1 & 1 \\ 1 & 1 & 1 & 1 \\ - 1 & - 1 & 1 & 1 \\ - 1 & 1 & 1 & - 1\end{matrix} ] & ( 14 )\end{matrix}$$

Similarly, for FIG. 6B:

$${T}_{i} {=}^{△} \frac{1}{2} [ \begin{matrix}1 & 1 & 1 & 1 \\ - 1 & 1 & - 1 & 1 \\ \frac{1}{2} & - \frac{1}{2} & - \frac{1}{2} & \frac{1}{2} \\ 1 & 1 & - 1 & - 1\end{matrix} ] {T}_{v} {=}^{△} \frac{1}{4} [ \begin{matrix}- 1 & - 1 & - 1 & - 1 \\ 1 & - 1 & 1 & - 1 \\ - 1 & 1 & 1 & - 1 \\ - 1 & - 1 & 1 & 1\end{matrix} ] \qquad ( 15 )$$

In both FIGS. 6A and 6B, state current i_{c1} contains primarily a fundamental frequency component and circulates within the SC to maintain charge balance of the four arm capacitor voltages Σv_{cap,a1}, Σv_{cap,b1}, Σv_{cap,a2}, and Σv_{cap,b2}. State current i_{c2} is the filter AC leakage current and is typically very small [11]. The state current iₜ₂ is primarily DC and charges all arm capacitors to maintain the average component of the four sums of arm capacitor voltages. Since the arm voltages are modulated from the sums of capacitor voltages:

vₐₛ=mₐₛΣv_{cap,as} (16)

v_{bs}=m_{bs}Σv_{cap,bs} (17)

Then together with Eq. (1)-(2), SC port voltages Vⱼₐ and V_{jb} can be regulated by the state currents iₜ₂ and i_{c1}. State current iₜ, represents the DC current flowing through the SC, and is the same as the current iⱼₖ in FIG. 3.

### Terminal Voltage and Power Flow Regulation

Based on Eq. (3)-(6), if the desired DC terminal voltages are known, the required port voltages Vⱼₐ and V_{jb} for every SC in the MT-MMC can be obtained:

V*ⱼₐ=v*_{d(j-1)}−v*_{dj}, ∀j ∈ [1,J] (18)

V*_{jb}=v*_{dj}−v*_{d(j+1)}, ∀j ∈ [1,J−1] (19)

V*_{jb}=v*_{dj}, j=J (20)

Quantities with a * superscript denote reference values. V*ⱼₐ and V*_{jb} are therefore the port voltage references assigned to each SC in row j to regulate the DC terminal voltages to v*_{dj}.

To control the power flow at each DC terminal, the DC terminal currents i_{dj} need to be regulated as:

$${i}_{dj}^{*} = \frac{{P}_{dj}^{*}}{{v}_{dj}} \qquad ( 21 )$$

For a row of low-stepping SCs (FIG. 4B), the relationship between corresponding DC terminal i_{dj} and row current iⱼ is:

i_{dj}=iⱼ−iⱼ₊₁, ∀j ∈ [0,J] (22)

For a row of high-stepping SCs (FIG. 4A), the relationship between corresponding DC terminal i_{dj} and row current iⱼ is:

i_{dj}=−iₓ+2iⱼ−iⱼ₊₁, ∀j ∈ [0,J] (23)

The modifier x denotes the first row of high-stepping SCs immediately above the jth row. If there is no low-stepping SCs, then x=j−1. If there are only low-stepping SCs above the jth row, then iₓ is 0. To ensure power balance between terminals of the MT-MMC, one DC terminal connection should be selected as the slack bus. Equations (22)-(23) can then be applied to every other DC terminal to obtain a relation matrix Tⱼ. For example, for a MT-MMC with four rows of high-stepping SCs, five terminals, and terminal d0 acting as the slack bus:

$$\begin{matrix}{i}_{dj} = {T}_{j} {i}_{j} = {[ \begin{matrix}{i}_{d 1} & {i}_{d 2} & {i}_{d 3} & {i}_{d 4}\end{matrix} ]}^{T} & ( 24 ) \\ {i}_{j} = {[ \begin{matrix}{i}_{1} & {i}_{2} & {i}_{3} & {i}_{4}\end{matrix} ]}^{T} & ( 25 ) \\ {T}_{j} {=}^{△} [ \begin{matrix}2 & - 1 & 0 & 0 \\ - 1 & - 2 & - 1 & 0 \\ 0 & - 1 & 2 & - 1 \\ 0 & 0 & - 1 & 2\end{matrix} ] & ( 26 )\end{matrix}$$

If the third row is changed to low-stepping SCs, then the relation matrix is modified as:

$${T}_{j} {=}^{△} [ \begin{matrix}2 & - 1 & 0 & 0 \\ - 1 & - 2 & - 1 & 0 \\ 0 & 0 & 1 & - 1 \\ 0 & - 1 & 0 & 2\end{matrix} ] \qquad ( 27 )$$

In any case, Tⱼ can then be inversed to obtain the reference for tⱼ based on desired DC terminal current:

i*ⱼ=Tⱼ⁻¹i*_{dj} (28)

Eq. (7) can then be used to yield the reference for iⱼₖ for each SC in MT-MMC

$${i}_{j 1}^{*} = {i}_{j 2}^{*} = … = {i}_{jk}^{*} = \frac{{i}_{j}^{*}}{{K}_{j}} \qquad ( 29 )$$

The above analysis and control design hold true for MT-MMC with combinations of high-stepping and low-stepping SCs.

TABLE II
Case Parameters

| | Value |
|---|---|
| Case 1 | |
| DC network voltages, v_{d0}, v_{d1}, v_{d2}, v_{d3} | 400, 300, 200, 100 kV |
| DC power transfer, P_{d0}, P_{d1}, P_{d2}, P_{d3} | slack, 0, 0, 160 MW |
| DC terminal currents, i_{d0}, i_{d1}, i_{d2}, i_{d3} | slack, 0, 0, 1600 A |
| Case 2 | |
| DC network voltages, v_{d0}, v_{d1}, v_{d2}, v_{d3} | 400, 300, 200, 100 kV |
| DC power transfer, P_{d0}, P_{d1}, P_{d2}, P_{d3} | slack, 720, −240, 160 MW |
| DC terminal currents, i_{d0}, i_{d1}, i_{d2}, i_{d3} | slack, 2400, −1200, 1600 A |
| Case 3 | |
| DC network voltages, v_{d0}, v_{d1}, v_{d2}, v_{d3}, v_{d4} | 300, 200, 200, 100 kV |
| DC power transfer, P_{d0}, P_{d1}, P_{d2}, P_{d3}, P_{d4} | slack, 320, −80, 120 MW |
| DC terminal currents, i_{d0}, i_{d1}, i_{d2}, i_{d3}, i_{d4} | slack, 1600, −400, 1200 A |
| Case 4 | |
| DC network voltages, v_{d0}, v_{d1}, v_{d2}, v_{d3} | 400, 300, 220, 100 kV |
| DC power transfer, P_{d0}, P_{d1}, P_{d2}, P_{d3} | slack, 780, −293, 153 MW |
| DC terminal currents, i_{d0}, i_{d1}, i_{d2}, i_{d3} | slack, 2600, −1333, 1533 A |

### Two-Layer Controller Design

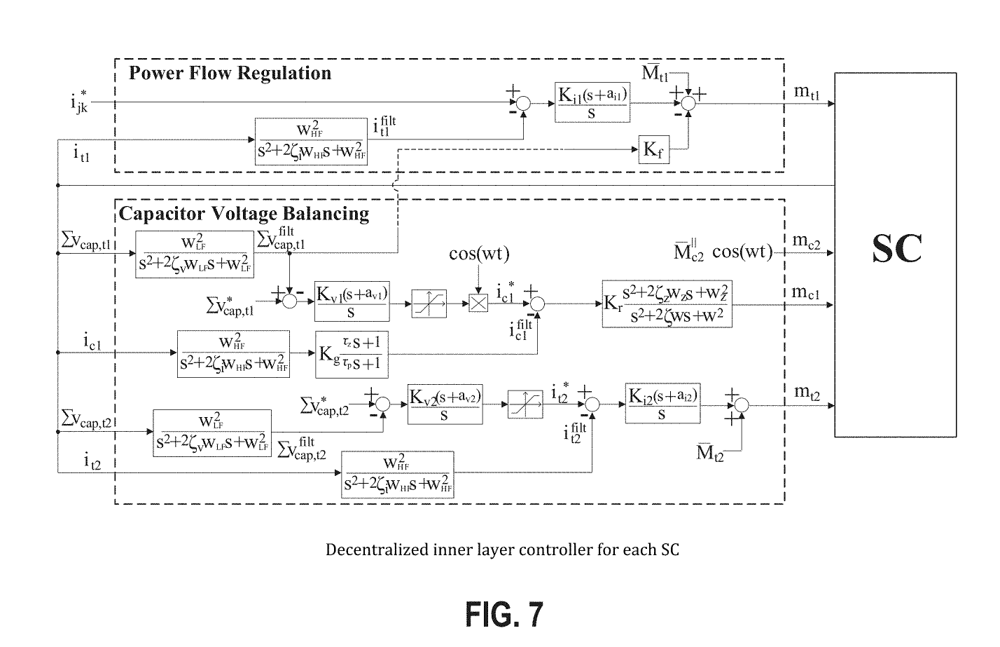

There are two layers of control mechanism for the MT-MMC: an outer layer which regulates the terminal voltage and power flow, and an inner layer which regulates the power transfer and capacitor charge balance within the SCs. The inner layer SC controllers are decentralized and can be designed separately for each SC, while one outer layer terminal controller is required for the entire MT-MMC. When new SCs are installed or existing SCs are removed, the inner layer controllers on the rest of the SCs are unaffected, and the outer layer terminal controller only needs to update the relation matrix Tⱼ accordingly. The inner layer control scheme for the SCs in FIG. 4 is shown in FIG. 7, which is adapted from the buck-boost MMC control scheme proposed in [11]. Based on Section 3.1, assuming only HBSMs are used and maximizing AC voltage modulation, the voltage references for each SC are:

Σv*_{cap,t1}=2(−V*ⱼₐ+V*_{jl )} (30)

Σv*_{cap,t2}=2(V*ⱼₐ+V*_{jb}) (31)

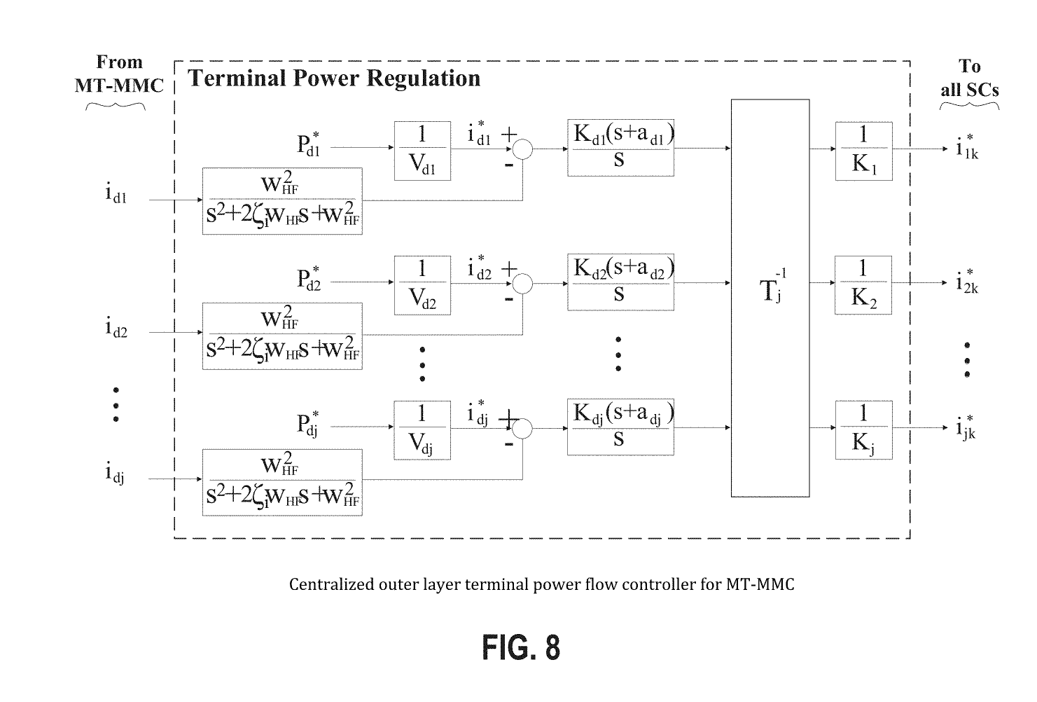

The outer later control scheme is shown in FIG. 8, where linear controllers are used to generate the reference for iⱼₖ according to (28)-(29).

### Case Studies

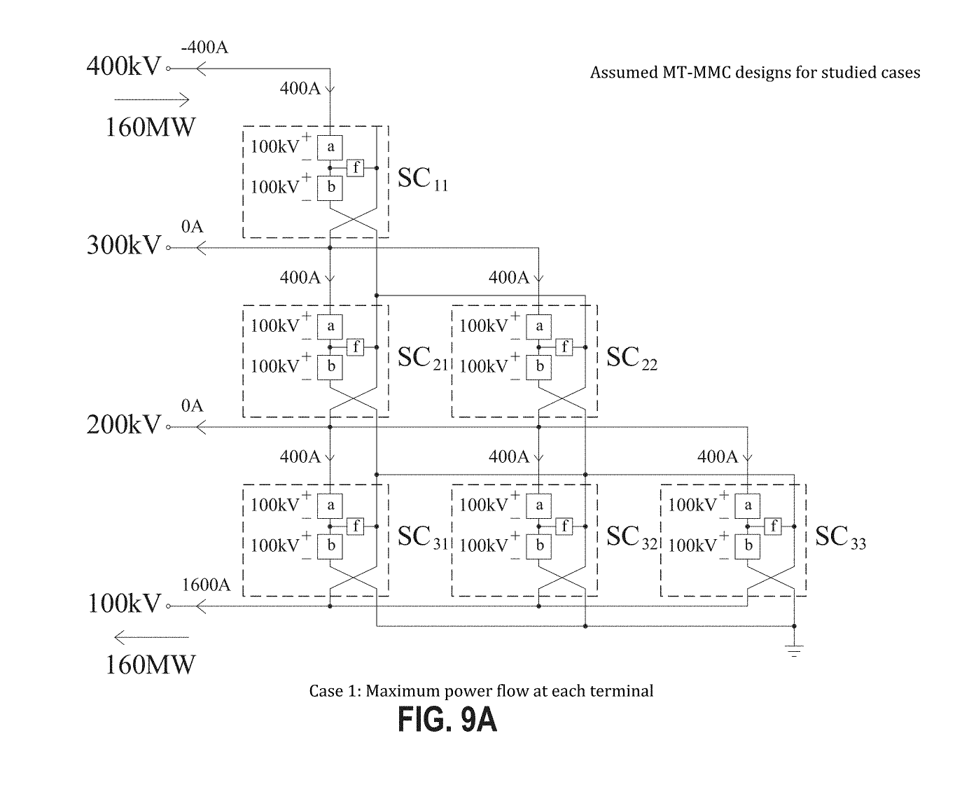

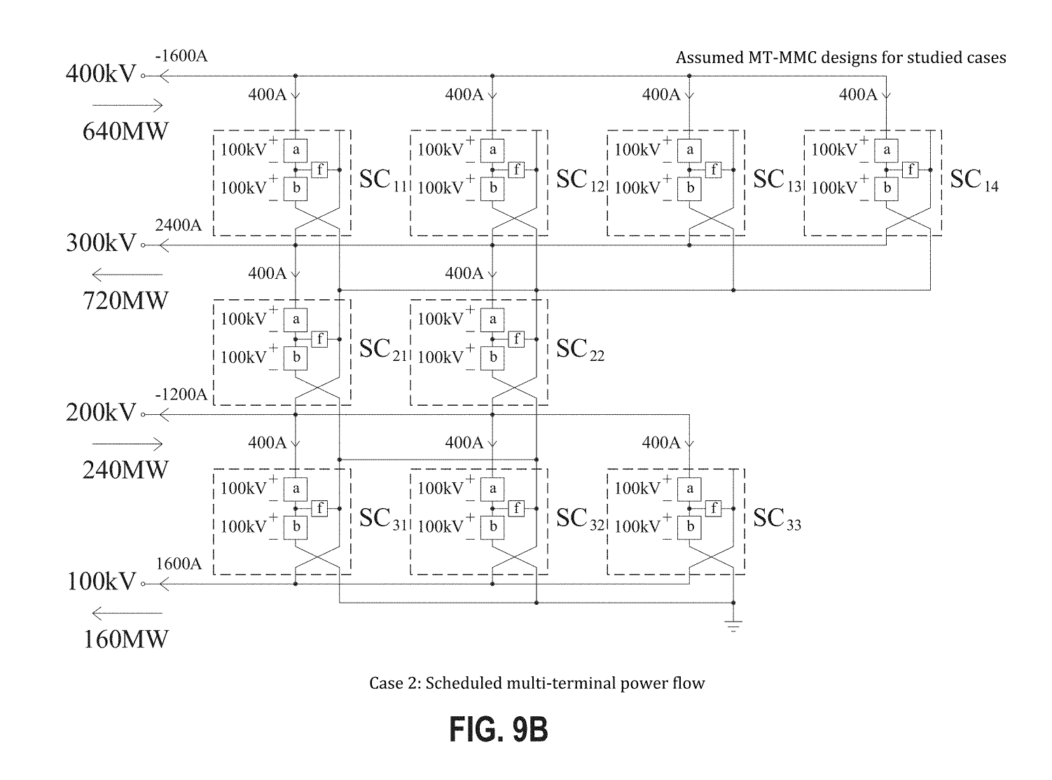

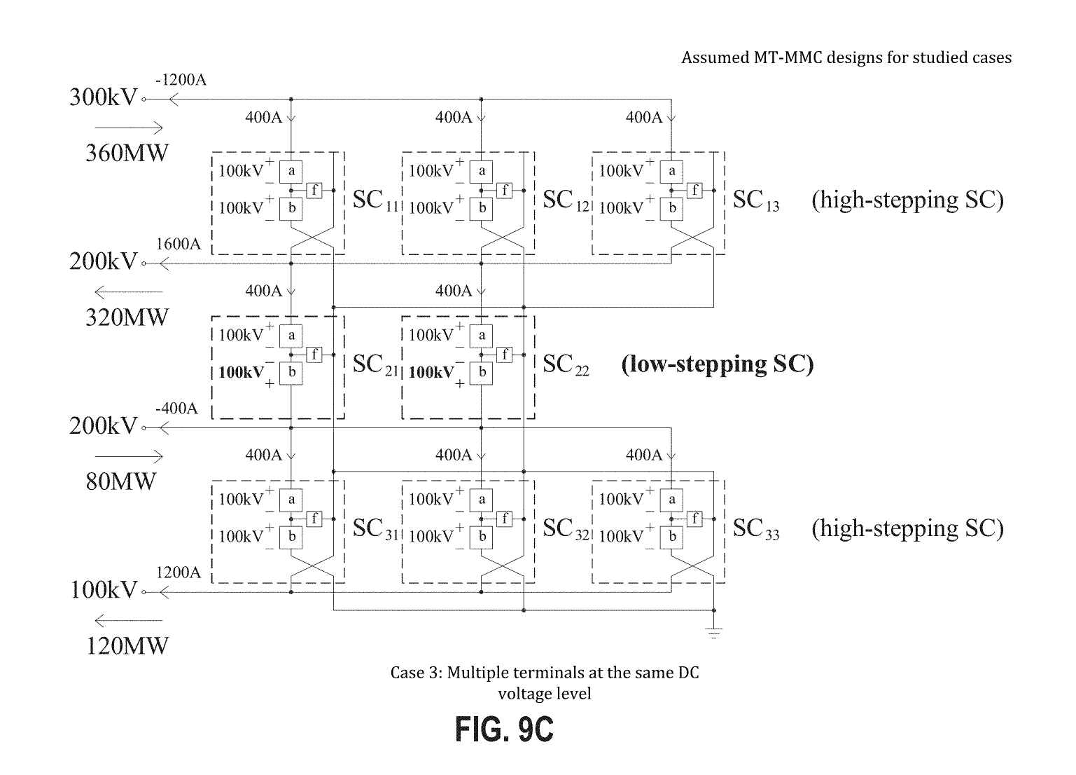

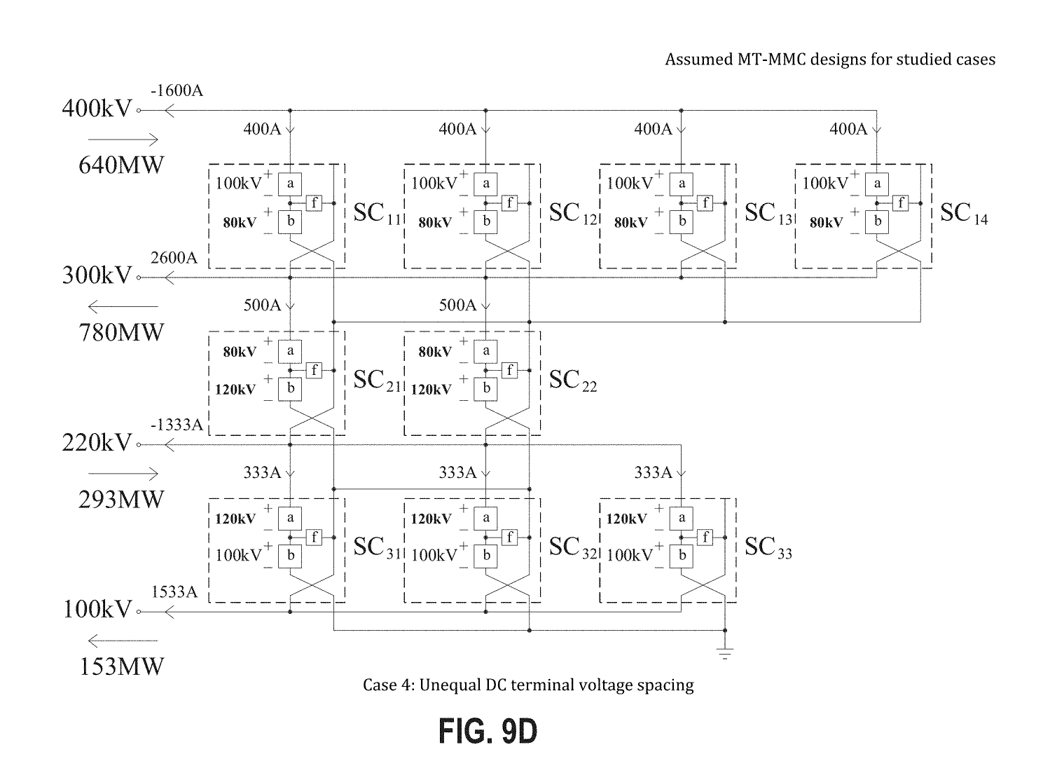

Four cases of terminal voltage and power requirements are presented to demonstrate the topology, SC and control design of the MT-MMC for various DC network interconnection scenarios. In each case, the number of SCs in each row, Kⱼ, is chosen so that iⱼₖ is around 400A for all SCs in the MT-MMC. The desired DC terminal voltages and power flows for each case are tabulated in Table II, and the assumed converter design for each case is illustrated in FIGS. 9A, 9B, 9C and 9D. Similar to FIGS. 4A and 4B, boxes represent the upper and lower arms in a SC, each including a minimum of two arms; f represents the AC filter. Required port voltages V_{jd} and V_{jb} are labeled.

### Case 1: Maximum Power Flow for Each Terminal

(J=3, K₁=1, K₂=2, K₃=3)

The maximum DC power can be transferred from any one terminal to other terminals. In this example case, each DC terminal has the capability to generate or consume the maximum power transfer of 160 MW. Since ΔVⱼ=_{dj} for all j, only the high-stepping SC in FIG. 4A is implemented. Each row of SCs must be designed to handle the worst case scenario, i.e. the highest possible current stress. This happens when the maximum power is transferred from terminal with the highest DC voltage rating (dj=d0) to terminal with the lowest DC voltage rating (dj=dJ). The resulting MT-MMC topology appears triangular.

### Case 2: Scheduled Multi-Terminal Power Flow

(J=3, K₁=4, K₂=2, K₃=3)

Each system connected at the terminal is either a DC power supply or load, with a known nominal power flow. Eq. (28)-(29) are used to find the iⱼ and Kⱼ required. In this example case, a high amount of DC power (640 MW) is transferred between terminals d0 and d1, therefore the top row j=1 processes a larger amount of DC power than in case 1. Four SCs are required at the top row to reduce i₁ₖ to 400 A.

### Case 3: Multiple Terminals at the Same DC Voltage Level

(J=3, K₁=3, K₂=2, K₃=3)

Two DC terminals d1 and d2 are both rated at 200 kV, and the scheduled DC power flow at each terminal is known. Since ΔV₂=0, the low-stepping SC of FIG. 4B is implemented at j=2 to connect the terminals. Eq. (28)-(29) with appropriate Tⱼ can again be use to find the required Kⱼ at each row to ensure that SC currents are around 400 A throughout the MT-MMC.

### Case 4: Unequal DC Terminal Voltage Spacing

(J=3, K₁=4, K₂=2, K₃=3)

Based on Eq. (18)-(20), unequal DC terminal voltage spacing causes Vⱼₐ≠V_{jb} for at least one row of SCs. In this example case, ΔV₁=100 kV, ΔV₂=80 kV, ΔV₃=120 kV and v_{d3}=100 kV. Since all ΔV are at least 80% of v_{d3}, it is assumed that implementing high-stepping SCs for all rows would yield the highest utilization of SMs. A detailed efficiency analysis would be required for cases with unequal DC terminal voltage spacings to determine the best SC design choice, which is outside the scope of this disclosure. The case parameters are chosen so that each SC arm processes the same amount of DC power as it does in Case 1 to 3. To interconnect networks with equal voltage spacings such as in Cases 1 to 3, since the DC current handling and the SC port voltage requirements are the same for all SCs, they can be of identical design to simplify the manufacturing and designing process. To interconnect networks with unequal voltage spacings such as Case 4, the SCs have to be designed differently, thereby reducing the savings the MT-MMC can realize with its high modularity.

### Comparative Analysis

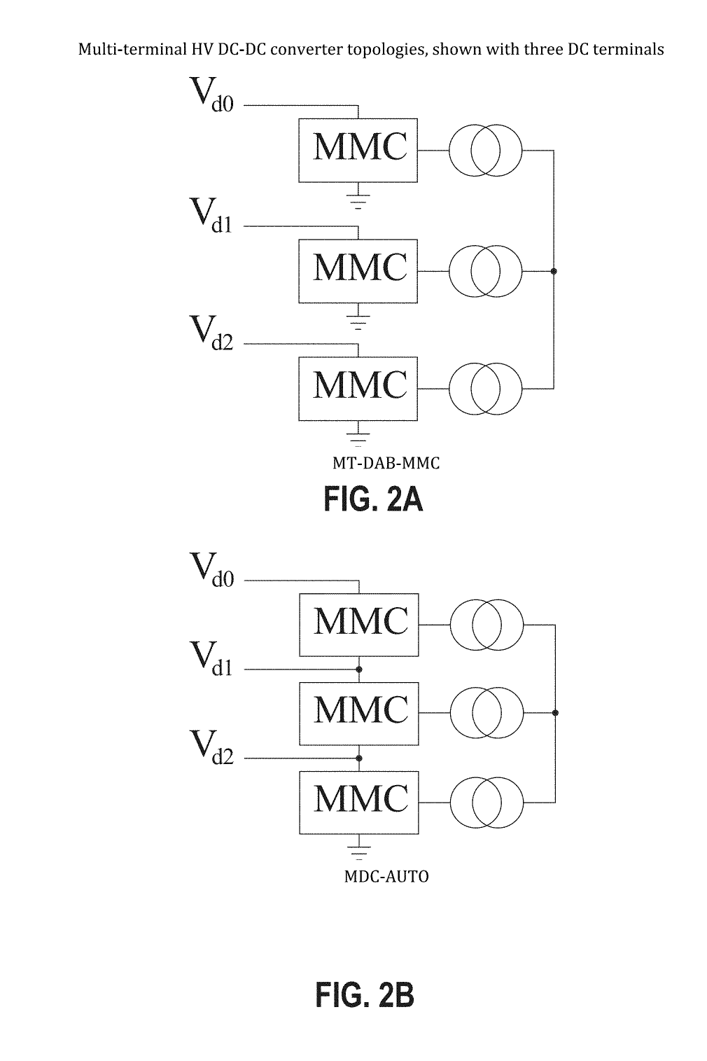

The MT-DAB-MMC is well-studied and is the conventional multi-terminal converter topology at HV. Therefore, the MT-MMC is compared with MT-DAB-MMC based on semiconductor effort and magnetic requirement. MT-DAB-MMCs are designed to meet the case requirements defined in Section 4 using expansions from the topology in FIG. 2A. It is assumed that the MT-DAB-MMC can parallel MMC arms and manipulate transformer terms ratio to maximize its semiconductor utilization at all terminals for all cases. Semiconductor effort is defined as the total MW rating of all SMs in the converter power circuit. Magnetic requirement is defined as the total MVA rating of the AC filters for the MT-MMC, and the total MVA rating of the transformers for the MT-DAB-MMC. The results of the comparative analysis is tabulated in Table III. MT-MMC is more cost-effective than MT-DAB-MMC for all three cases, achieving 25-60% reduction in semiconductor effort and 60-80% reduction in magnetic requirement. The reductions MT-MMC can achieve vary depending on design requirements.

TABLE III
Comparative Analysis between MT-MMC and MT-DAB-MMC

| | MT-MMC | MT-DAB-MMC |
|---|---|---|
| Case 1 | | |
| Semiconductor effort | 480 MW | 640 MW |
| Magnetic requirement | 240 MVA | 640 MVA |
| Case 2 | | |
| Semiconductor effort | 720 MW | 1760 MW |
| Magnetic requirement | 360 MVA | 1760 MVA |
| Case 3 | | |
| Semiconductor effort | 640 MW | 880 MW |
| Magnetic requirement | 320 MVA | 880 MVA |
| Case 4 | | |
| Semiconductor effort | 720 MW | 1866 MW |
| Magnetic requirement | 360 MVA | 1866 MVA |

The MDC-AUTO can generally achieve 70-75% reduction in semiconductor effort [8] when compared with the MT-DAB-MMC, higher than the MT-MMC because the MDC-AUTO transfers AC power between MMCs directly through a centralized AC link. However, by dispensing with the centralized AC link, the MT-MMC offers the following advantages over MDC-AUTO:
i. Truly modular structure with high scalability.
ii. Decentralized controllers enabling autonomous and independent control of SCs within MT-MMC structure.
iii. No DC voltage stress imposed across windings.
iv. Higher reliability in case of SC failure, as shown in Table I.

The MT-MMC is an alternative method for the interconnection of multiple HVDC networks that provides more control and design freedom than existing converter topologies, and it can be a highly cost-effective solution depending on the application and required terminal ratings.

### Simulation Results

From the four cases of Section 4, MT-MMC designs for Case 3 and Case 4 are simulated in PLECS using a switched model to verify the operation of the proposed MT-MMC topology and control designs for multi-terminal power flows. Case 3 is chosen to verify the combined operation of high-stepping and low-stepping SCs, and Case 4 is chosen to observe the effects of unequal spacing between DC terminal voltage levels on the MT-MMCs. At t=0, the capacitors are charged and there is no power transfer between terminals. The scheduled terminal power flows are applied at t=0.1, and a reversal of all scheduled terminal powers is applied at t=0.5. Voltage commands Vⱼₐ and V_{jb} are set with open-loop control according to Eq. (18)-(20), while the current commands are regulated by the closed-loop control scheme shown in FIGS. 7 and 8. The design parameters for both simulations are detailed in Table IV. The sizing of the passive components follow the approach in [11], and the AC voltage modulation is maximized while using only HBSMs throughout the MT-MMC.

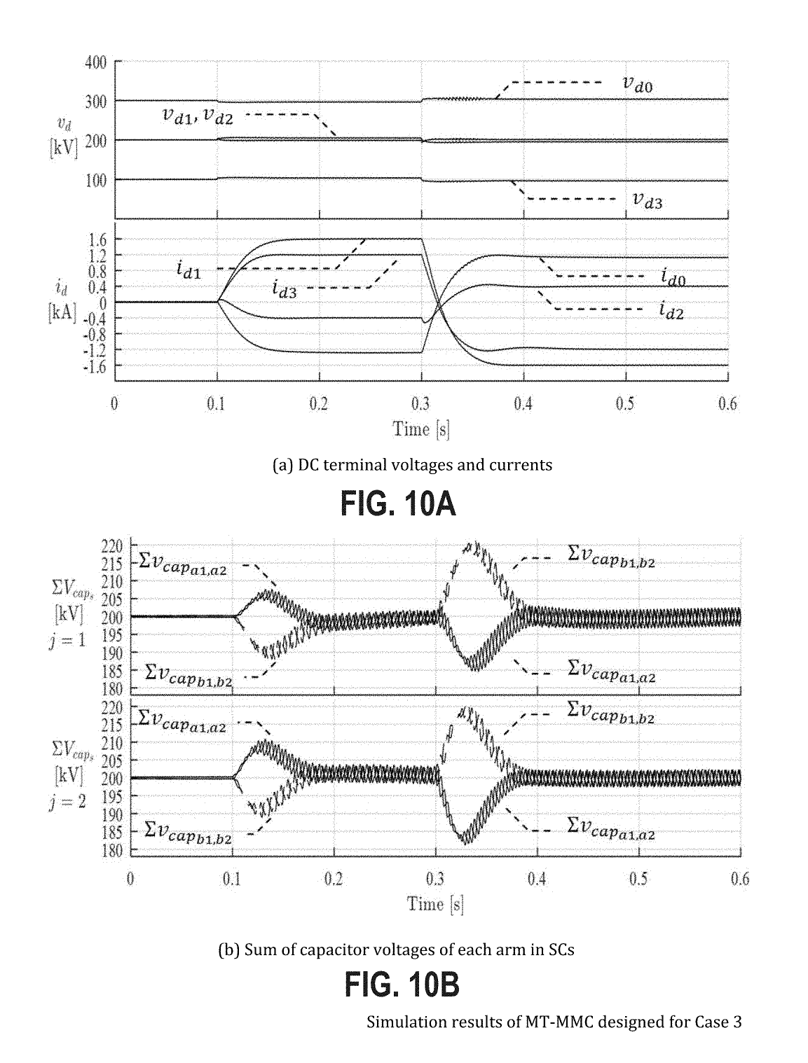

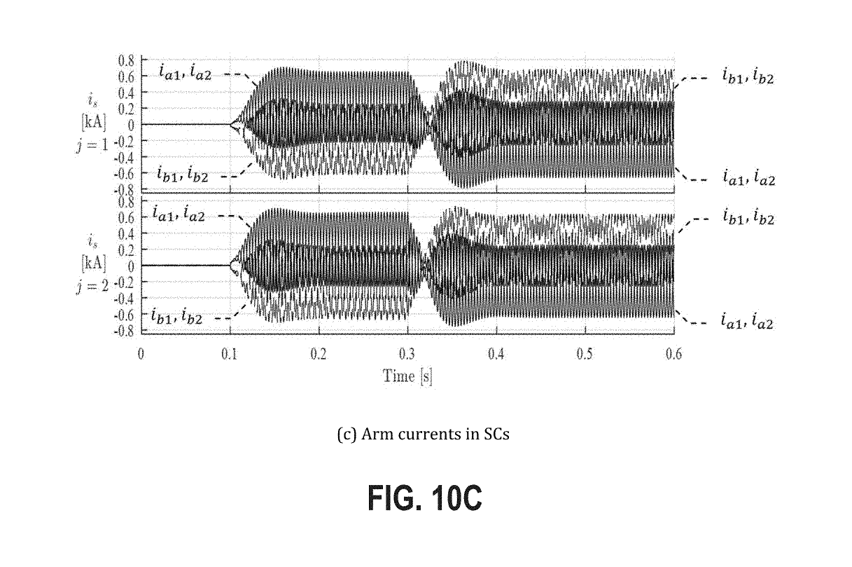

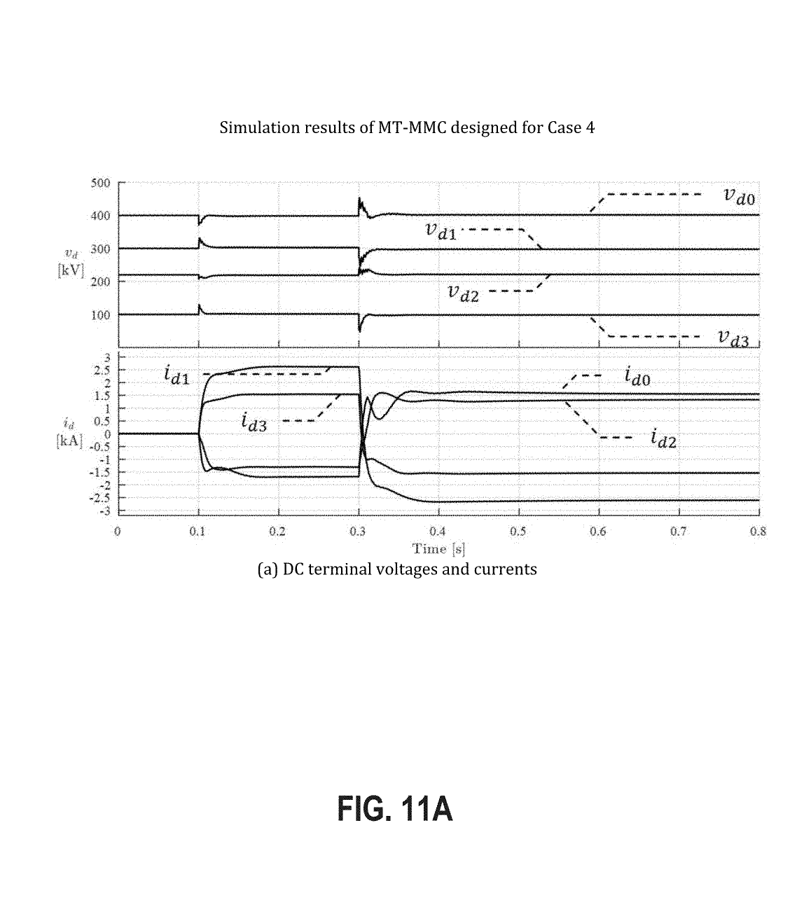

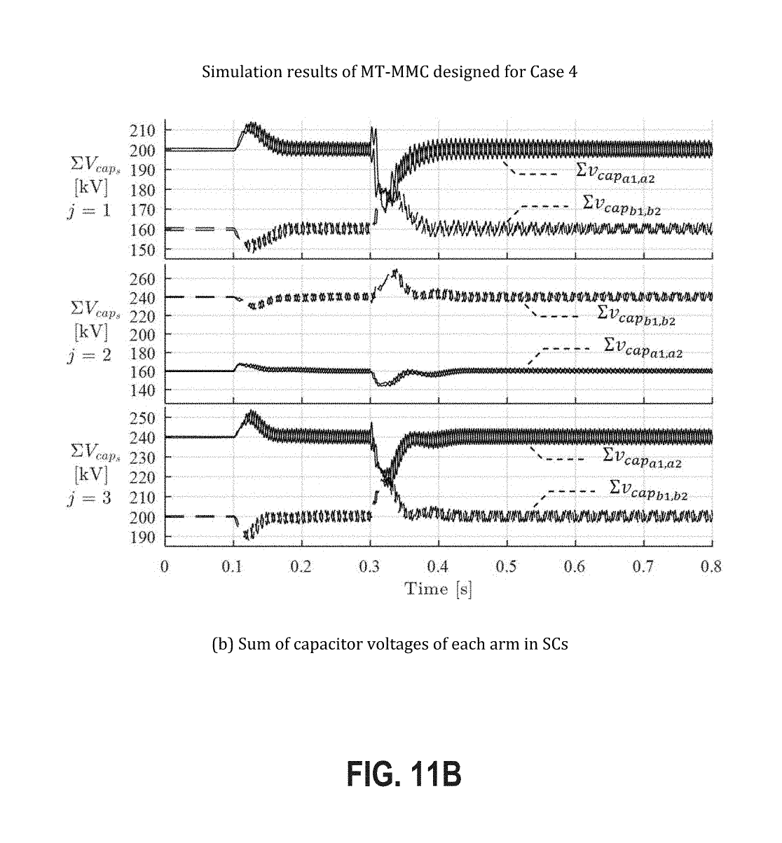

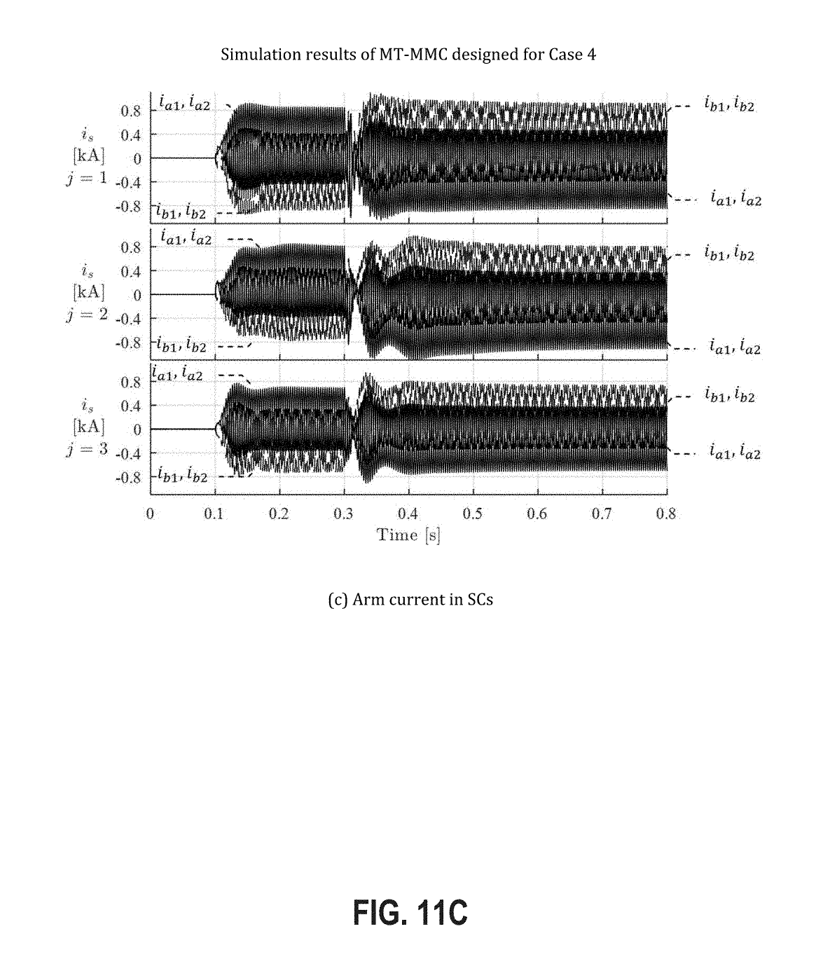

FIGS. 10A, 10B and 10C show the simulation result of Case 3. FIG. 10A verifies the DC terminal power regulation, FIG. 10B shows less than 10% overshoot for average capacitor voltages during power flow changes, and FIG. 10C shows that the peak current stress is around 700 A in steady-state. Rows j=1 and j=3 both have high-stepping SCs and therefore have nearly identical voltage and current dynamics. FIGS. 11A, 11B and 11C show the simulation result of Case 4. DC terminal power regulation and capacitor voltage dynamics are again verified in FIG. 11A and 11B. Due to under-utilization of installed SMs in rows j=1 and j=2, the maximum current stresses in steady-state have increased to 920 A in rows j=1 and j=2, as shown in FIG. 11C. Although current stress has not increased in row j=3, a higher number of SMs are required for that row.

TABLE IV
Subconverter Parameters (Case 3 and Case 4)

| Parameter | Value |
|---|---|
| Fundamental modulating frequency, w | 2π150 rad/s |
| No. of SMs per arm Nₐ, N_{b} (Case 3) | 5, 5 |
| No. of SMs per arm N₁ₐ, N_{1b} (Case 4) | 5, 4 |
| No. of SMs per arm N₂ₐ, N_{2b} (Case 4) | 4, 6 |
| No. of SMs per arm N₃ₐ, N_{3b} (Case 4) | 6, 5 |
| SM capacitor, C | 0.40 mF |
| Nominal SM capacitor voltage, V_{c}ⁿ | 40 kV |
| Arm choke, Lₐ, Rₐ | 33 mH, 0.66 Ω |
| Terminal line impedance, Lᵢₙ, Rᵢₙ | 82 mH, 3.1 Ω |
| Filter magnetizing inductance, Lₘ | 33.2 H |
| Filter leakage inductance, Lₗₖ | 28 mH |

### Conclusion

In this disclosure, the MT-MMC is proposed as the first truly modular multi-terminal HV DC-DC converter with high modularity, high scalability and low magnetic requirement. The MT-MMC is made up of multiple SCs that can be individually controlled with de-centralized controllers, and can be connected/disconnected without critically affecting the operation of the rest of the MT-MMC power circuit, making the MT-MMC very accommodating to future expansions of HVDC systems. The MT-MMC also realizes large reduction in semiconductor effort and magnetic requirement in comparison to the conventional MT-DAB-MMC, which translates to significant cost savings. The MT-MMC is therefore an attractive multi-terminal solution for converter manufacturers and power system developers, with suitable characteristics to act as a central DC hub for a star-connected DC grid topology.

### Additional Embodiments

The preceding disclosure proposes two example subconverter (SC) designs, given by FIGS. 4A and 4B. However, these are not the only possibilities. SC designs based on other dc-dc converter circuits can also be utilized, if they are capable of:
1) Supporting a DC voltage between its terminals;
2) Regulating a DC current between its terminals;
3) Ensuring charge balancing of internal capacitors.

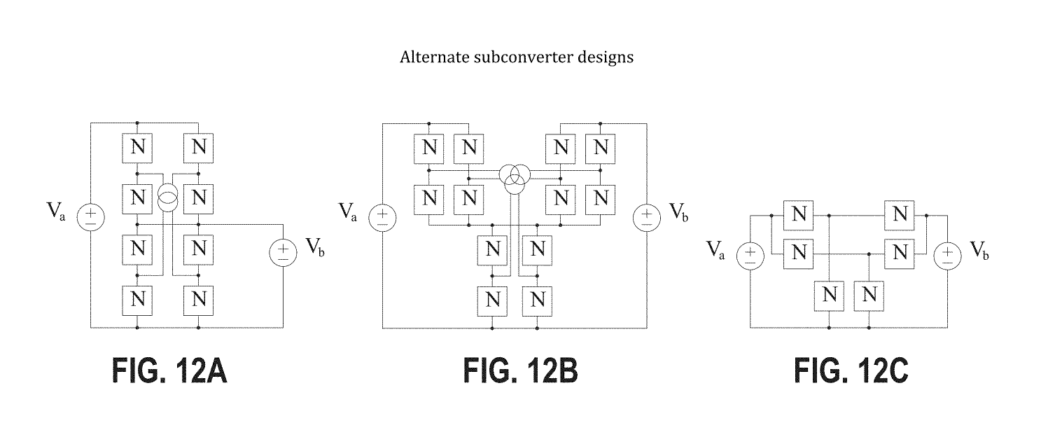

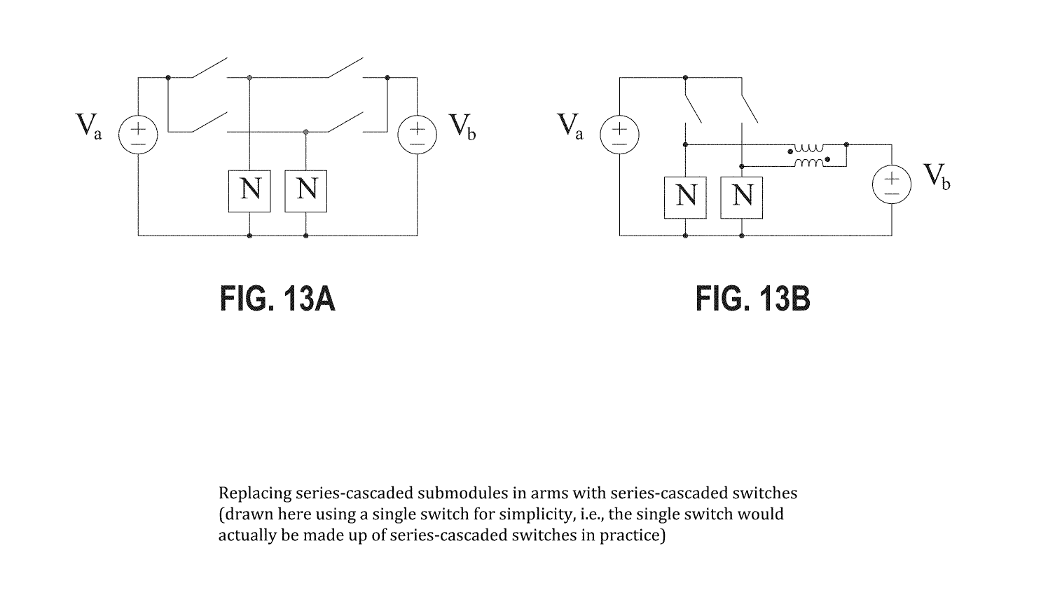

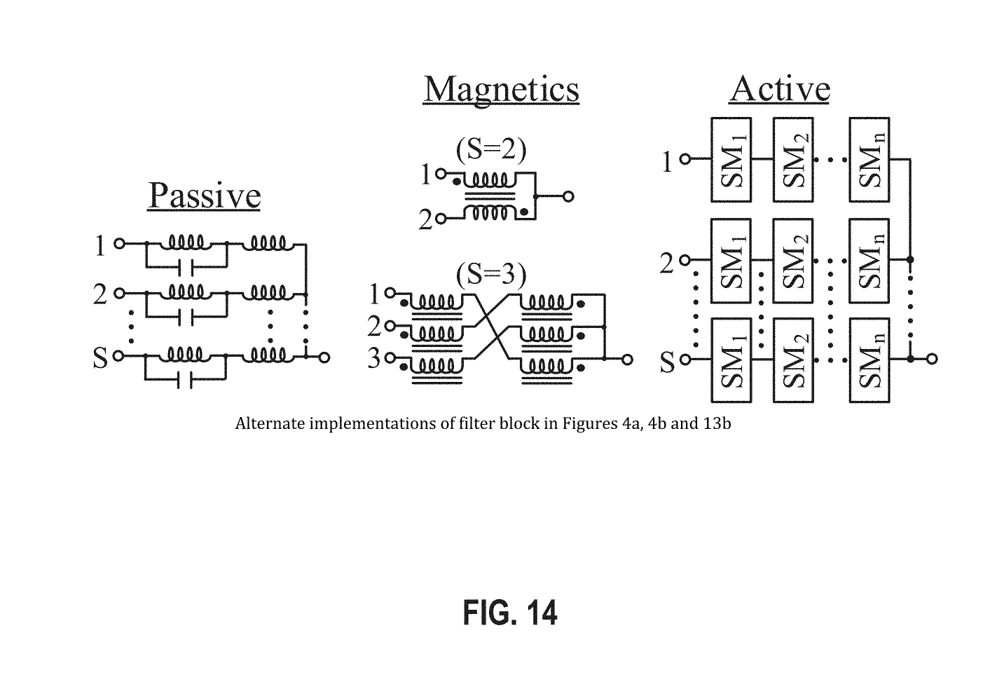

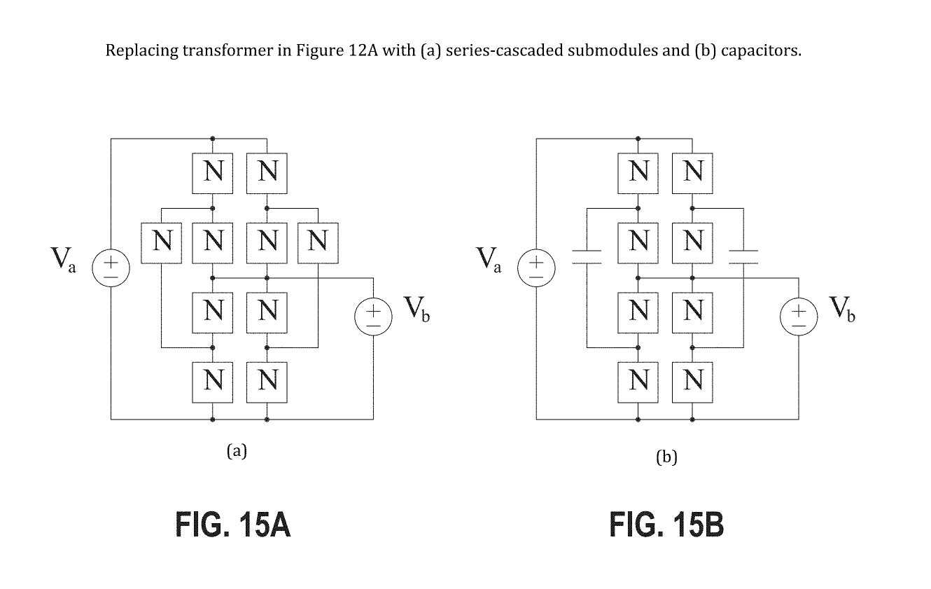

FIGS. 12A, 12B and 12C illustrate three other potential SC topologies where each arm comprises N series-cascaded submodules. These are drawn with S=2 for simplicity (keeping with the convention in FIGS. 6A and 6B). However, it should be stressed that an arbitrary number of submodule strings can be interleaved, as similarly recognized in FIGS. 4A and 4B. For example, the dc-dc topologies in FIGS. 12A, 12B and 12C can alternatively be realized with three interleaved strings of submodules, i.e., S=3. The topologies in FIGS. 12A, 12B and 12C are further described in [12].

For the SC designs in FIGS. 4A, 4B, 12A, 12B and 12C, there exist variations for each of them that differ in physical realization of required operational functionalities. For example, all but one of the SC arms in each string can be replaced with series-cascaded switches (as opposed to using series-cascaded submodules). Example cases for this variation are illustrated by FIGS. 13A and 13B for the SC design in FIGS. 12C and 4B, respectively.

Furthermore, the use of the coupled inductor in FIGS. 6A and 6B for implementation of the filter block (refer to FIGS. 4A and 4B) is merely an example. This is not the only possibility. Other variations of the filter block implementation are illustrated in FIG. 14, which include active filtering (via use of additional half-bridge and/or full-bridge submodules), other magnetics structures such as zig-zag transformers, and passive filters.

Furthermore, SC designs that require a central ac connection between the different arms, for example, as shown in FIGS. 12A and 12B, do not exclusively require transformers to enable said connection. The transformers can be replaced with other suitable structures, such as series-cascaded half-bridge and/or full-bridge submodules, and capacitors. The main criteria are that the chosen element must be capable of supporting a dc voltage bias and must allow the circulation of ac currents. To demonstrate, example FIGS. 15A and 15B show how the transformer in FIG. 12A can be replaced with series-cascaded submodules and capacitors, respectively.

The modifications and circuit configurations shown in FIGS. 13A, 13B, 14, 15A and 15B are merely example figures to demonstrate the possible variations, and should not be considered as limitations to the practice.

The use of full-bridge submodules (or submodules that can function as full bridge submodules in certain situations) is also known. Throughout this document, the term “full-bridge submodules” should be understood to encompass conventional full-bridge submodules and submodules that have full bridge functionality and other enhancements.

As well, whereas the benefits of the converter topology are immense in the context of transmission level HDVC networks, this is not essential. In some embodiments, the MT-MMC can be utilized in medium-voltage direct current (MVDC) systems characterized by DC voltage levels ranging from a few kilovolts to several tens of kilovolts. As well, whereas specific operating conditions and parameters are disclosed as part of the simulations and others, persons of ordinary skill will understand that these are included for illustration, only, and are not intended to be limiting. There is no theoretical limit to the number of rows (J) and the number of subconverters in each row (Kj), therefore the MT-MMC structure is not limited to the geometrical shapes illustrated in this document.

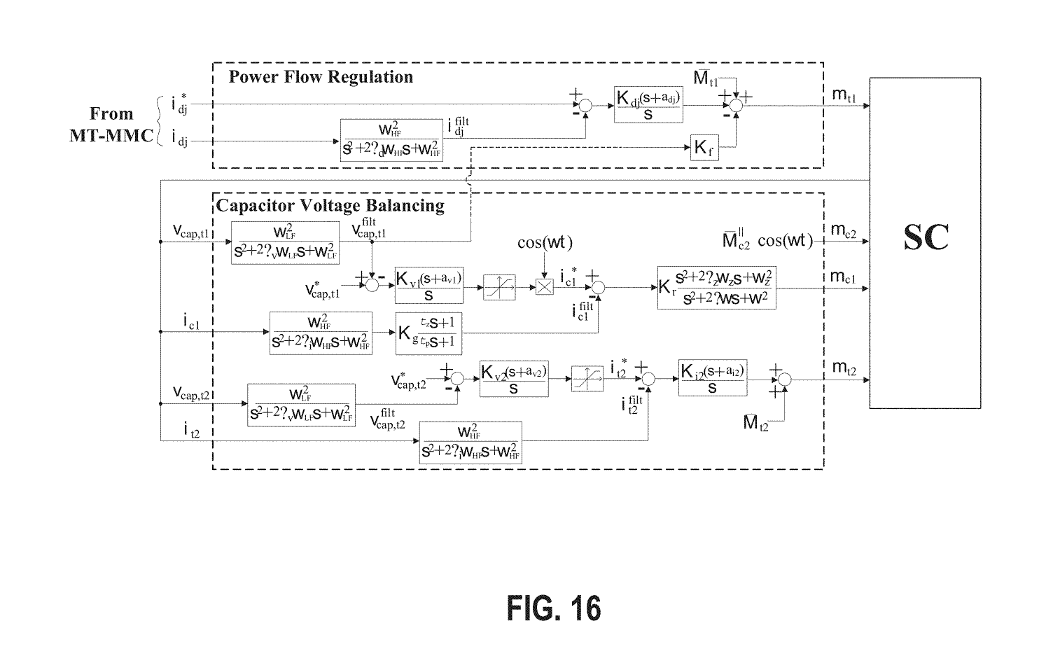

The two-layer controller structure illustrated by FIGS. 7 and 8 is only one possible method of controlling the MT-MMC. For example, it is also possible to control the MT-MMC using a single-layer type controller structure where the dc terminal current, i_{dj}, is directly fed to the iₜ₁ current controllers of SCs in the jth row. Such a controller structure is illustrated in FIG. 16. Utilizing a single-layer type controller structure offers faster response and smaller steady-state error on the dc terminal voltages because it reduces the level of cascading control systems, but it relinquishes precise power regulation of individual SCs in the same row.

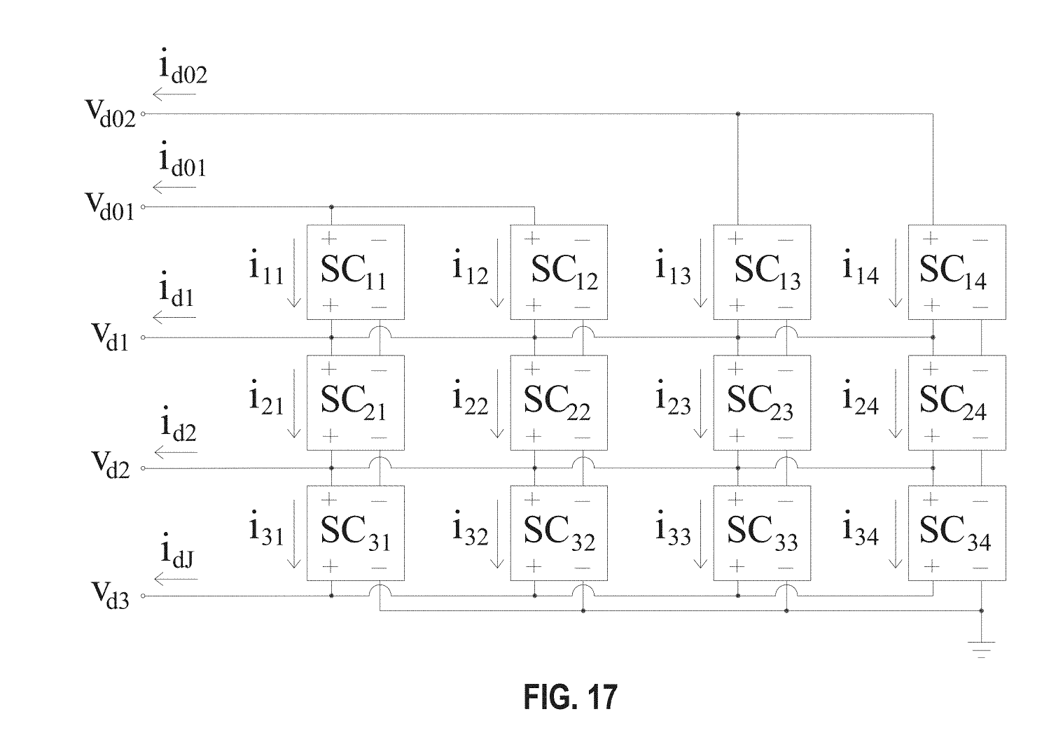

Furthermore, all SCs within a given row are not constrained to adopting the same local controller. This can potentially provide added control flexibility. For example, it is possible to separate the SCs within a given row into subsets, then connect the subsets to different dc terminals with the same voltage potential. By changing the local dc power command for each subset of SCs, the power flow diverted to the two terminals can be variable. An example converter design utilizing this procedure is shown in FIG. 17.

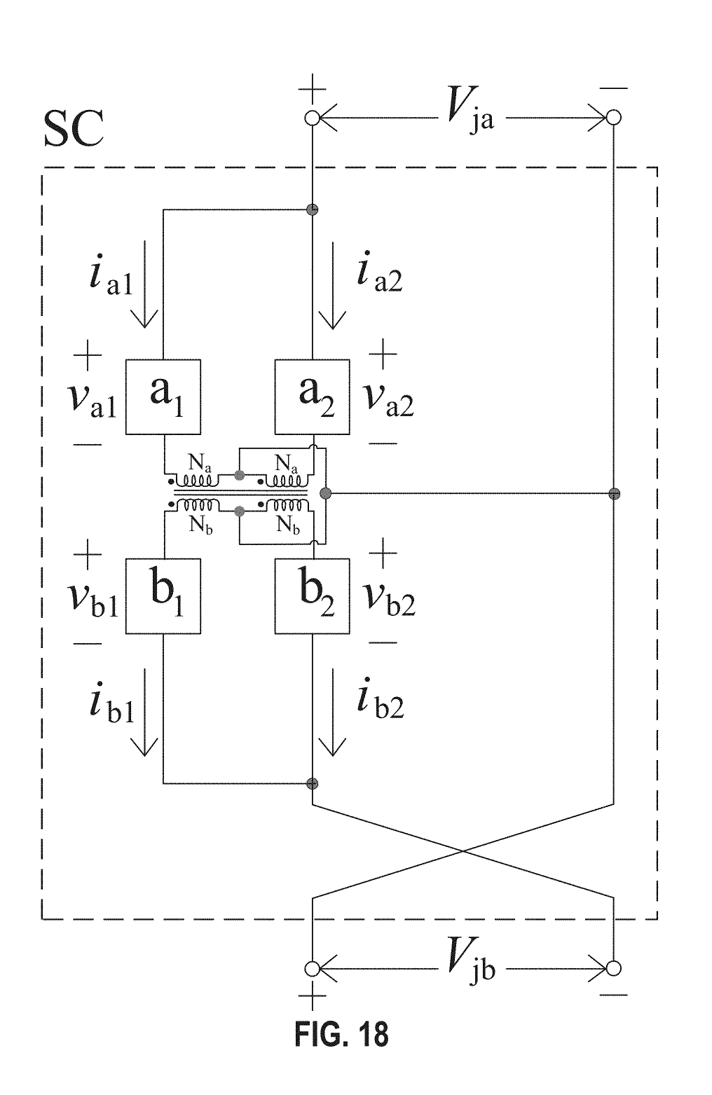

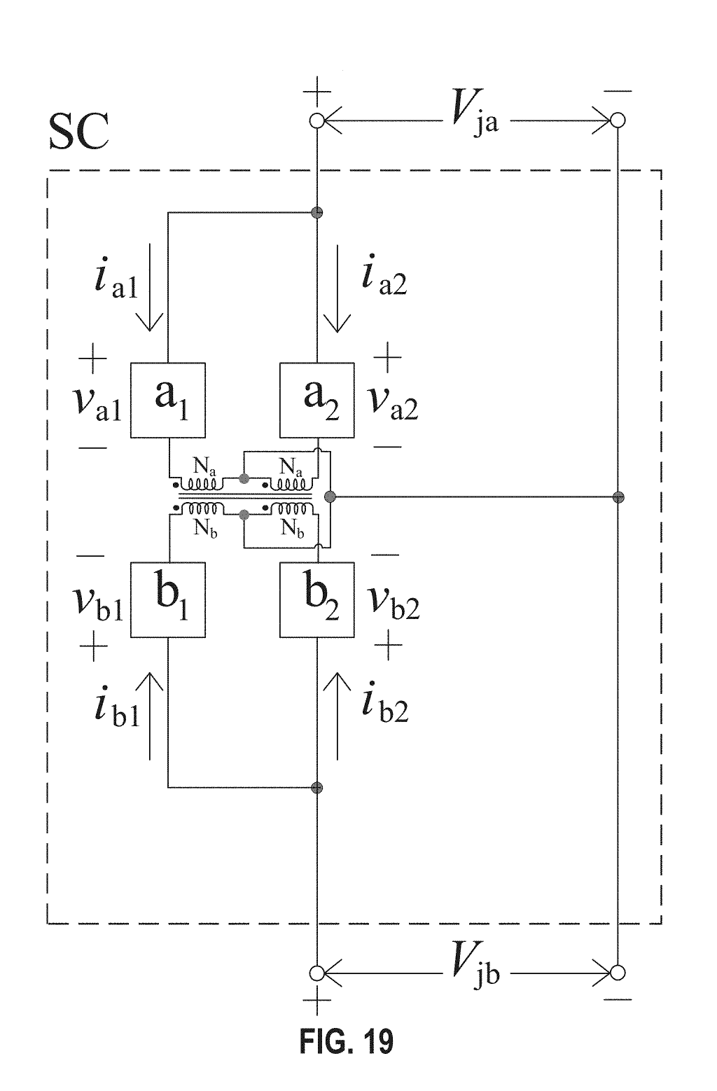

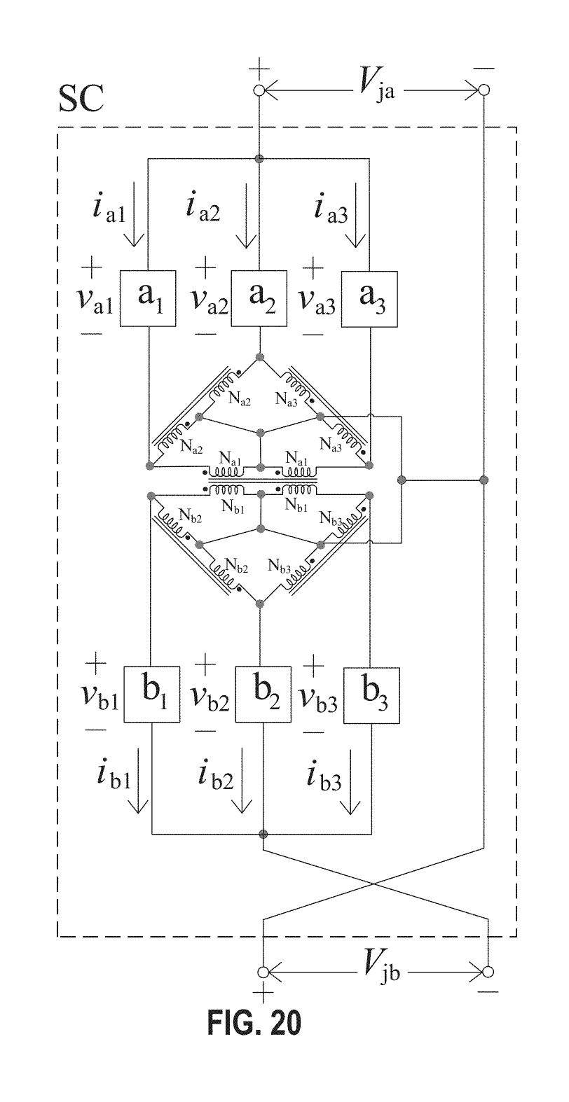

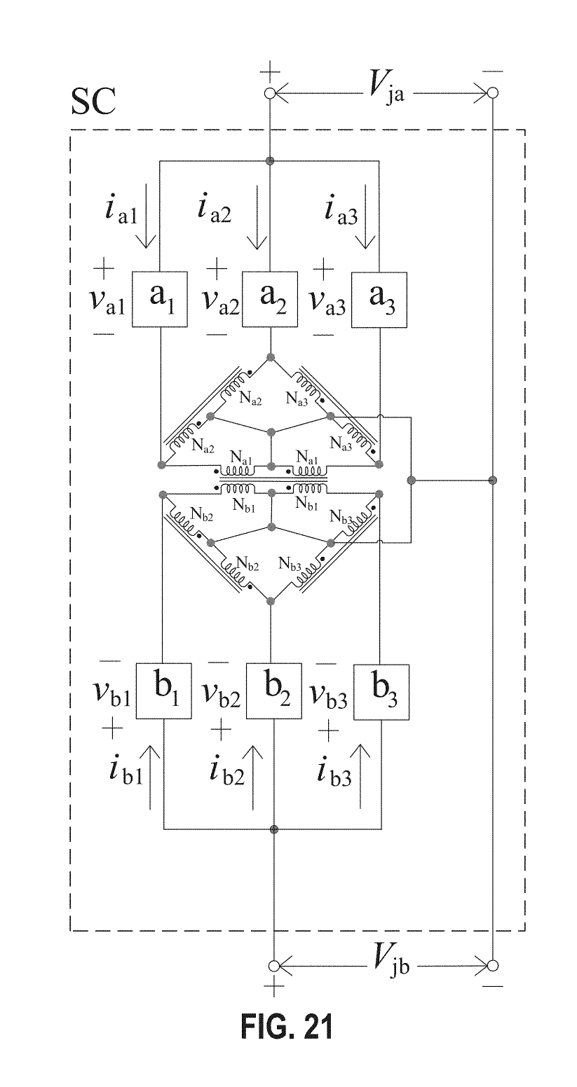

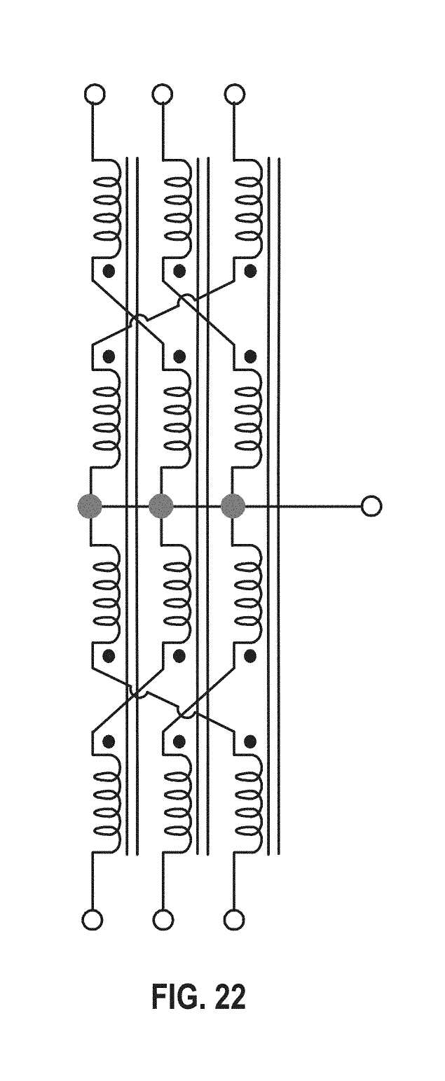

FIGS. 18, 19, 20 and 21 show four example SC topologies that integrate center-tapped winding transformers within the SC structure. Specifically, (i) FIGS. 18 and 19 are alternative realizations of the single-phase SCs shown respectively in FIGS. 4A and 4B, and (ii) FIGS. 20 and 21 are three-phase variants of the single-phase SCs shown respectively in FIGS. 4A and 4B.

FIG. 18 shows an example single-phase subconverter design that includes/incorporates a center-tapped winding transformer within the subconverter structure from FIG. 6A (and also from FIG. 4A with S=2).

FIG. 19 shows an example single-phase subconverter design that includes/incorporates a center-tapped winding transformer within the subconverter structure from FIG. 6B (and also from FIG. 4B with S=2).

FIG. 20 shows an example three-phase subconverter design that includes/incorporates delta connected center-tapped winding transformers within the subconverter structure from FIG. 4A (with S=3).

FIG. 21 shows an example three-phase subconverter design that includes/incorporates delta connected center-tapped winding transformers within the subconverter structure from FIG. 4B (with S=3).

In some embodiments, the SC topologies in FIGS. 18-21 allow the ac currents circulating between a & b arms to be different (and also allows a & b arms to synthesize different ac voltages) by judicious selection of the transformer turns ratios, while, simultaneously, transformer windings are all at zero average voltage potential and cancellation of dc flux within the transformer cores is achieved. In some scenarios, some embodiments such as the examples in FIGS. 18-21 may allow a more flexible range of possible dc voltages that can be achieved between their terminals, as compared to structures detailed in FIGS. 4A, 4B, 6A, 6B. Therefore, MT-MMC dc port voltages do not have to be integer multiples of one another (or equal to one another), for example, as shown in Table II. The dc port voltages can be designed arbitrarily in a cost-effective manner.

It should be recognized that other transformer circuits for FIGS. 18-21 can be utilized that achieve the same SC functionality and operational benefits. For example, FIG. 22 shows an alternative realization of the three-phase transformer circuit deployed in FIGS. 20 and 21. Here, the top 3 (and bottom 3) connections are for arms a1, a2, a3 (and for arms b1, b2, b3).

While all SCs within a given MT-MMC have been assumed to be of identical type and/or design in the preceding description, this is not essential.

It should be recognized that it is possible to utilize different SC types and/or designs within a single MT-MMC structure.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

### REFERENCES

[1] M. P. Bahrman and B. K. Johnson, “The abcs of hvdc transmission technologies,” IEEE Power and Energy Magazine, vol. 5, no. 2, pp. 32-44, 2007.
[2] D. Jovcic, D. van Hertem, K. Linden, J. P. Taisne, and W. Grieshaber, “Feasibility of dc transmission networks,” in 2011 2nd IEEE PES International Conference and Exhibition on Innovative Smart Grid Technologies, 2011, pp. 1-8.
[3] Q. Mei, X. Zhen-lin, and W. y. Wu, “A novel multi-port dc-dc converter for hybrid renewable energy distributed generation systems connected to power grid,” in 2008 IEEE International Conference on Industrial Technology, 2008, pp. 1-5.
[4] J. Zeng, W. Qiao, L. Qu, and Y. Jiao, “An isolated multiport dc-dc converter for simultaneous power management of multiple different renewable energy sources,” IEEE Journal of Emerging and Selected Topics in Power Electronics, vol. 2, no. 1, pp. 70-78, 2014.
[5] K. Filsoof and P. W. Lehn, “A bidirectional modular multilevel dc-dc converter of triangular structure,” IEEE Transactions on Power Electronics, vol. 30, no. 1, pp. 54-64, 2015.
[6] ______, “A bidirectional multiple-input multiple-output modular multilevel dc-dc converter and its control design,” IEEE Transactions on Power Electronics, vol. 31, no. 4, pp. 2767-2779, 2016.
[7] D. Jovcic and W. Lin, “Multiport high-power Icl dc hub for use in dc transmission grids,” IEEE Transactions on Power Delivery, vol. 29, no. 2, pp. 760-768, 2014.
[8] W. Lin, J. Wen, and S. Cheng, “Multiport DC-DC Autotransformer for Interconnecting Multiple High Voltage DC Systems at low Cost,” IEEE Trans. Power Electron., vol. PP, no. 99, pp. 1-13, 2015.
[9] J. A. Ferreira, “The multilevel modular DC converter,” IEEE Trans. Power Electron., vol. 28, no. 10, pp. 4460-4465, October 2013.
[10] G. J. Kish, M. Ranjram and P. W. Lehn, “A modular multilevel DC/DC converter with fault blocking capability for HVDC interconnects,” IEEE Trans. Power Electron., vol. 30, no. 1, pp. 148-162, January 2015.

[11] S. H. Kung and G. J. Kish, “A modular multilevel hvdc buck-boost converter derived from its switched-mode counterpart,” IEEE Transactions on Power Delivery, vol. PP, no. 99, pp. 1-1, 2017.

[12] S. H. Kung and G. J. Kish, “A unified modular multilevel DC/DC converter structure with flexible AC power transfer controls,” 2017 IEEE 18th Workshop on Control and Modeling for Power Electronics (COMPEL), Stanford, Calif., 2017, pp. 1-6.

What is claimed is:

1. A multi-terminal DC-DC converter comprising:
a plurality of subconverter rows, each row including a plurality of independently-controllable subconverter circuits;
the plurality of subconverter rows including a first subconverter row and an adjacent second subconverter row, wherein subconverter circuits of the first subconverter row having interconnected terminals connected to terminals of corresponding subconverter circuits of the second subconverter row, the interconnected terminals of the first subconverter row providing a DC terminal.

2. The multi-terminal DC-DC converter of claim 1, wherein each subconverter circuit comprises a plurality of terminals and is configured to support a DC voltage between at least two of its plurality of terminals.

3. The multi-terminal DC-DC converter of claim 1, wherein a subconverter circuit of the plurality of independently-controllable subconverter circuits includes at least two strings of converter arms configured to allow a current to circulate internally for balancing internal charge between the converter arms, wherein each arm includes a series of cascaded submodules.

4. The multi-terminal DC-DC converter of claim 1 comprising a plurality of inner layer subconverter circuit controllers each configured to regulate terminal voltage and capacitor charge balance within a corresponding subconverter circuit.

5. The multi-terminal DC-DC converter of claim 1 wherein at least one of the plurality of subconverter circuits includes a center-tapped transformer.

6. The multi-terminal DC-DC converter of claim 1 wherein at least one of the plurality of subconverter circuits includes a delta-connected center-tapped transformer.
